(19) United States
(12) Patent Application Publication
(10) Pub. No.: US 2016/0021913 A1
(43) Pub. Date: Jan. 28, 2016

(54) Protein additive for dry or wet pet food

(71) Applicants: Jasmin Linda Heilbron, Miami, FL (US); Elio Cajiga, Miami, FL (US)

(72) Inventors: Jasmin Linda Heilbron, Miami, FL (US); Elio Cajiga, Miami, FL (US)

(73) Assignee: Arthur Duarte, Miami, FL (US)

(21) Appl. No.: 14/805,675

(22) Filed: Jul. 22, 2015

Related U.S. Application Data
(60) Provisional application No. 62/001,726, filed on May 22, 2014.

(51) Int. Cl. A23K 1/16; A23K 1/18

(52) U.S. Cl. CPC A23K 1/1631; A23K 1/1853

(57) ABSTRACT

The invention is directed to a water-based food additive or broth to be added to dry pet food, Particularly for pet species having a carnivorous natural diet such as dogs and cats, would resolve this problem. The product comprises an extraction of protein components from protein-rich animal foods, such as eggs, fish, meat, and poultry. Some other macro nutrients, such as fats, in particular oils having a significant omega-3 fatty acid component, may also be extracted. The product is provided as a liquid, or as a powder to which water is to be added. The product is then mixed with dry pet food, as is commonly used with water to make the pet food more appealing to the pet; however the advantage of the product is that it provides a nutritional boost in the form of additional protein. The product also provides a scent and flavor enhancement to attract the pet, and ensure complete consumption of the food by the pet.

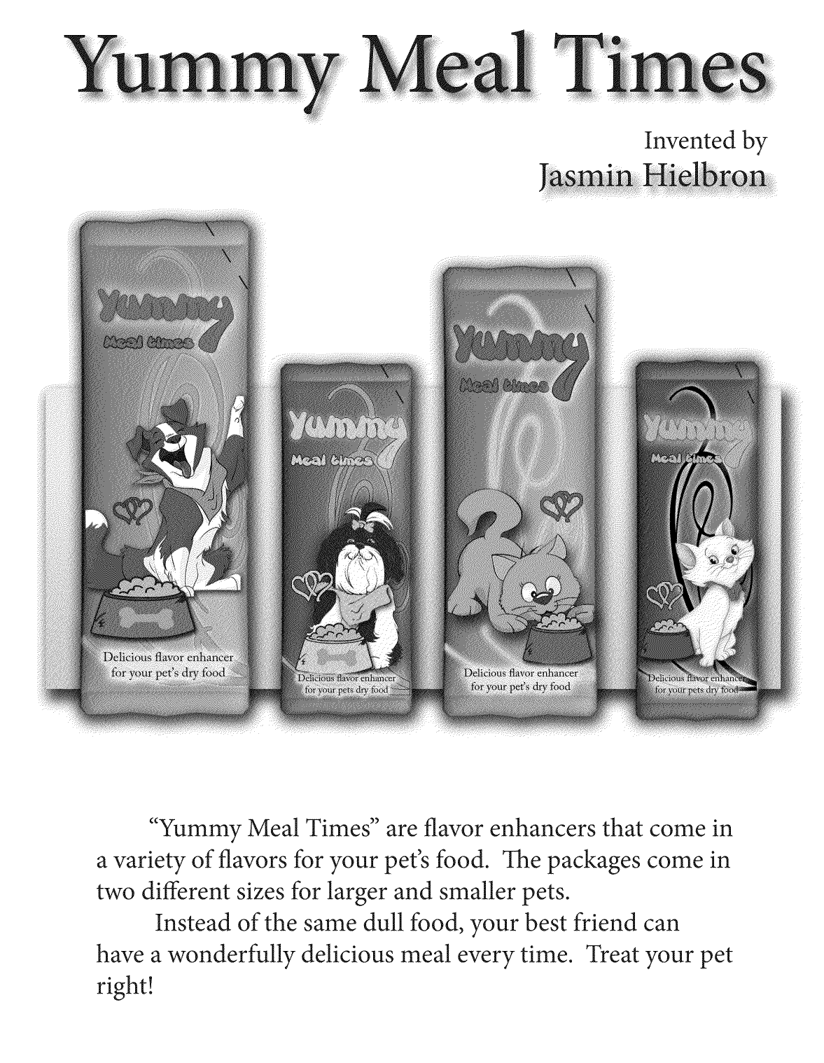

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to pet care supplies and accessories and in particular to a protein additive for dry pet food. Many pet owners are disappointed by the nutritional quality of the dry pet food provided for their pets, particularly cats and dogs. Some pets are also finicky eaters, and may refuse to eat dry pet food in certain circumstances. Special pet foods which are advertised as having improved nutritional quality are expensive, and often provide only a marginal improvement. A water-based food additive or broth to be added to dry pet food, particularly for pet species having a carnivorous natural diet such as dogs and cats, would resolve this problem. The product comprises an extraction of protein components from protein-rich animal foods, such as eggs, fish, meat, and poultry, to be mixed with dry pet food. The product also provides a scent and flavor enhancement to attract the pet, and ensure complete consumption of the food by the pet.

### SUMMARY OF THE INVENTION

Accordingly, the invention is directed to a water-based food additive or broth to be added to dry pet food, particularly for pet species having a carnivorous natural diet such as dogs and cats, would resolve this problem. The product comprises an extraction of protein components from protein-rich animal foods, such as eggs, fish, meat, and poultry. Some other macronutrients, such as fats, in particular oils having a significant omega-3 fatty acid component, may also be extracted. The product is provided as a liquid, or as a powder to which water is to be added. The product is then mixed with dry pet food, as is commonly used with water to make the pet food more appealing to the pet; however the advantage of the product is that it provides a nutritional boost in the form of additional protein. The product also provides a scent and flavor enhancement to attract the pet, and ensure complete consumption of the food by the pet.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

No drawing is provided for the disclosed invention, because a drawing is not necessary for the understanding of the invention under 35 U.S.C. §113, 37 C.F.R. §1.81(a), and MPEP §608.02 (III) (B).

### DETAILED DESCRIPTION OF THE INVENTION

Referring now to the invention in more detail, the invention is directed to a water-based food additive or broth to be added to dry pet food, particularly for pet species having a carnivorous natural diet such as dogs and cats, would resolve this problem. The product comprises an extraction of protein components from protein-rich animal foods, such as eggs, fish, meat, and poultry. Some other macronutrients, such as fats, in particular oils having a significant omega-3 fatty acid component, may also be extracted. The product is provided as a liquid, or as a powder to which water is to be added. The product is then mixed with dry pet food, as is commonly used with water to make the pet food more appealing to the pet; however the advantage of the product is that it provides a nutritional boost in the form of additional protein. The product also provides a scent and flavor enhancement to attract the pet, and ensure complete consumption of the food by the pet.

The product is provided in two exemplary embodiments. The first exemplary embodiment comprises a liquid, such as a broth, which is packaged in a bottle, tube, or similar container. To use the first exemplary embodiment, the user removes the cap from the container and mixes the liquid with dry pet food. The mixture is then fed to the pet immediately.

The second exemplary embodiment comprises a powder, which is packaged in a foil envelope or packet. To use the second exemplary embodiment, the user tears open the package and mixes the powder with a quantity of water specified on the external surface of the package, then mixes the resulting liquid with dry pet food. The mixture is then fed to the pet immediately.

The product is preferably provided in at least two varieties, one for cats and one for dogs. Each variety of the product is preferably packaged in at least two single serving container sizes for the feeding of all sizes of cats and dogs. The product is preferably provided in a large package containing a plurality of smaller, single serving containers for the convenience of the user.

The product is preferably manufactured from proteins and omega-3 fatty acid components extracted from protein-rich animal foods, such as eggs, fish, meat, and poultry. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1. A water-based food additive that comprises an extraction of rich protein components such as eggs, fish, meat, and poultry, providing a scent and flavor enhancement to attract the pet and ensure complete consumption of the food by the pet.
